(19) United States
(12) Patent Application Publication
(10) Pub. No.: US 2014/0085465 A1
(43) Pub. Date: Mar. 27, 2014

(54) METHOD AND SYSTEM FOR LOCATING A PERSON

(71) Applicants: Michael Angermann, Grafelfing (DE); Patrick Robertson, Ammerland (DE)

(72) Inventors: Michael Angermann, Grafelfing (DE); Patrick Robertson, Ammerland (DE)

(73) Assignee: DEUTSCHES ZENTRUM FÜR LUFT- UND RAUMFAHRT E.V., Köln (DE)

(21) Appl. No.: 14/115,176

(22) PCT Filed: May 4, 2012
(86) PCT No.: PCT/EP2012/058222

§ 371 Date: Nov. 1, 2013

(30) Foreign Application Priority Data
May 4, 2011 (DE) 10 2011100 412.6

(51) Int. Cl. H04N 7/18

(52) U.S. Cl. CPC H04N 7/18
USPC 348/143

(57) ABSTRACT

The method for locating a person, particularly within a building, first of all involves capturing the movement of at least one foot of the pedestrian by using an inertial sensor arranged in or on the shoe of the user. In addition, it involves capturing those phases of time during the movement of the pedestrian in which the internal sensor does not measure any further essential acceleration apart from acceleration due to gravity. Hence, quiescent phases of the foot and/or the shoe of the pedestrian are captured in which the foot or the shoe is essentially not moving. During a large number of the detected quiescent phases of the foot and/or the shoe, an image of the surroundings of the pedestrian is recorded by a camera arranged in or on the shoe. By processing the images from at least two quiescent phases, particularly quiescent phases at successive times, a movement of the foot and/or of the shoe is ascertained. The at least one inertial sensor can then be calibrated using the movement of the foot or of the shoe which is ascertained from the images.

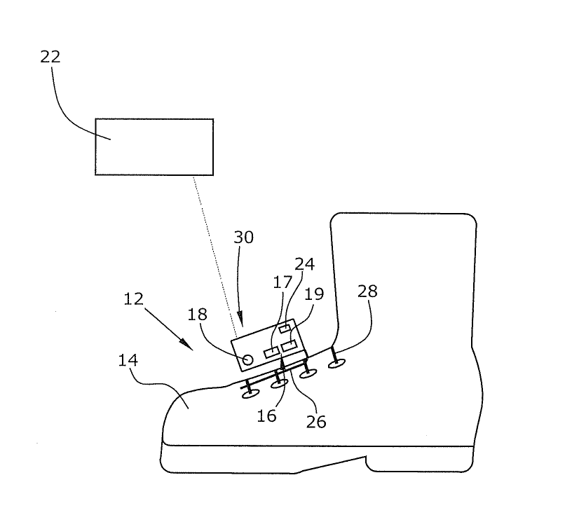

The invention relates to a method and a system for locating a person, such as a pedestrian, for example, in particular inside a building.

Owing to the absence of GPS signals, there is no possibility inside a building to determine the absolute position of a person moving inside this building, i.e. a pedestrian. It is known to use inertial sensors, such as acceleration sensors or rotation rate sensors, for example, for the determination of position. It is a drawback that the error of the determined estimated value of the position increases drastically over time due to noise and biases of the sensors.

An approach to a solution of this problem provides for a simultaneous locating of a person and mapping of the surroundings (SLAM: Simultaneous Localization and Mapping). In this context, inertial sensors and cameras could be used as sensors, for example. In this case, problems arise from the motion blur in the images and from the necessity of very short exposure times and the associated increased image noise. Further problems are caused by the strong drift of the inertial sensors.

A method for creating a map using inertial sensors carried or worn by a person is described in WO-A-2011/033100. This method can be implemented with assistance by a camera (cf. p. 30 para. 4 of WO-A-2011/033100).

It is an object of the invention to provide a method and a system for an accurate locating of a person, in particular inside a building, with the method and the system being simple to implement.

The object is achieved, according to the invention, with the features of the method claim 1 and claim 9 directed to a system. Advantageous embodiments of the invention are defined in the dependent claims.

The invention will be described hereinafter with reference to an example using a pedestrian that walks through an area and carries the sensor system on his foot or his shoe. As an alternative, the person could also be crawling or moving in any other manner. The sensor system could also be arranged on knee or elbow protectors, for example. For the invention it is decisive that the sensor system is located on a body part or a piece of clothing of the person, which experiences phases of rest as the person moves, during which phases its movement is slowed down or during which it is almost motionless. In particular, these locations include a foot and a shoe, a knee or leg and trouser leg and/or knee or leg protectors, elbows or arms and shirt sleeves or arm protectors, a hip or a waistband.

According to the invention a pedestrian is located, in particular inside a building, by means of the following method steps: First, the movement of at least one foot of the pedestrian is detected by means of an inertial sensor provided in or on the shoe of the user. In those periods of time during which the inertial sensor measures no further substantial acceleration other than gravitational acceleration, it is detected that this foot of the pedestrian does not move together with the associated shoe. Thus, it is in a phase of rest. During a plurality of the detected phases of rest of the foot, an image of the surroundings of the pedestrian is captured by a camera provided in or on the shoe. This may be a simple digital camera as it is used in cell phones, for example. The position of the foot or shoe of the pedestrian is determined based on the change in position and/or orientation of objects visible on a plurality, in particular successive rest phase images. The inertial sensor is then calibrated using the movement information obtained from these images.

The invention utilizes the fact that, when walking, a foot stands still for a certain period of time. The camera images are captured during this period of time so that no motion blur occurs. Therefore, in the interest of avoiding motion blur, it is no longer ultimately necessary to choose very short exposure times so as to avoid increased image noise. According to the invention, it is thus possible to (better) calibrate the inertial sensor (Inertial Measuring Unit—IMU) by using the estimates improved by the camera images. Further, fewer camera images are required so that a reduced computing time can be achieved. This is due to the fact that longer exposure times can be selected because motion blur is avoided, so that the quality of the available images can be enhanced because of the reduced image noise so that fewer images have to be processed which, however, are of a higher quality.

According to the invention it thus becomes possible to locate a pedestrian inside a building without a special infrastructure having to be provided for this purpose.

It is preferred that a map of the surroundings of the pedestrian is created based on the images captured and that in particular a SLAM is performed.

For example, a 3D model of the surroundings can be created based on the images captured, into which model in particular at least parts of the images captured are integrated. This 3D map can be used for future applications such as navigation applications, for example.

In a preferred embodiment of the present method, the rest phase of a pedestrian's foot is detected in addition or as an alternative to the inertial sensor by evaluation of the camera images by detecting rest phases through the evaluation of images.

It is further preferred that the aperture angle is chosen as a function of the stride length of the pedestrian, such that the images of two successive rest phases overlap in their edge zones so that they can be combined into an overall image. The camera used may be a CCD sensor, for instance. For example, the focal distance of the camera can be 70 mm or less, preferably 50 mm or less, and particularly preferred 30 mm or less, respectively relative to the 35 mm format.

Moreover, it is preferred that the camera has a high f-number (small aperture) so that a large depth of field can be achieved such that, if possible, all objects present in the surroundings of the pedestrian appear sharp in the image. For example, f-numbers X, Y or Z may be used.

It is also possible to use an omnicam as the camera.

The camera may be provided in the heel of the pedestrian's shoe or at the instep. Attaching the camera at the instep allows for a better view of the surroundings of the pedestrian.

It is preferred that objects visible on a first image captured are detected and, in a further step, the visual characteristics of these objects present in the surroundings are described and stored so that these objects can be recognized in a successive image.

In a preferred embodiment of the present method, image data of the surroundings of a plurality of pedestrians are acquired. These data are transmitted to a computer, in particular a central processing computer. As an alternative, image data could also exchanged via a peer-to-peer network, for example directly via Wireless LAN or Bluetooth, or via Wireless LAN and Internet without using a central server. Thereafter, a general map of the surroundings of the pedestrians is created from the image data gathered. This method could be used, for example, in an application similar to “Open Streetmap”.

The invention further refers to a system for locating a pedestrian, in particular inside a building. This system comprises an inertial sensor to be attached in or to a shoe of the user for detecting the movement of at least one foot of the pedestrian. Further, the system comprises a camera for capturing images of the surroundings of the pedestrian during the detected rest phases of the foot. Further, a data transmission device is provided for the transmission of the captured image data from the camera to a processing computer. This data transmission device may be a Bluetooth transceiver or a Wireless LAN transceiver, for example. Preferably, the data are transmitted in a wireless manner.

For example, the processing computer may also be located in a cell phone, a smart phone or a similar transportable terminal device. On this processing computer, the image data gathered are processed as described in the context of the method.

The system of the present invention can comprise all characteristics described in connection with the present method and vice versa.

It is particularly preferred that the system comprises a fastening device for fastening the camera and/or the inertial sensor to a conventional shoe. This fastening device may for instance be a fastening clip for fastening the entirety of the components mentioned to the shoelace. Thus, it has become possible in a very simple manner to fasten a small module that includes all components to the shoe of the user so that the present method can be carried out without requiring a special shoe for that purpose. Tests have shown that there is a period of time during which also the instep of a pedestrian's foot stands still so that a camera fastened there can capture suitable images without motion blur during such rest phases.

It is preferred that the camera is connected with the inertial sensor in a rigid manner so that it can be ensured that the camera does not move during the detected rest phases.

The following is an explanation of a preferred embodiment of the invention with reference to the drawing.

The FIGURE is a schematic illustration of an embodiment of a system according to the invention.

The shoe 14 worn on the foot 12 of a pedestrian, not illustrated, comprises shoelaces 28. The module 30 is fastened to the shoelaces 28 by means of a clip 26. The module includes a camera 18 and an inertial sensor 16. As the inertial sensor 16 a 3D inertial sensor can be used which has at least three rotation rate sensors 17 as well as three axial acceleration sensors 19. Further, the module 30 comprises a data processing device 24. The latter processes the data of the images captured by the camera 18 and calibrates the inertial sensor 16. Further, the images can be transmitted to an external processing computer 22, for instance in a wireless manner.

1-12. (canceled)

13. A method for locating a person in an occupied area, comprising:
detecting, by at least one inertial sensor, the movement of a body part and/or a clothing of a person moving in said occupied area which experiences phases of rest during said movement, during which phases the body part and/or clothing moves significantly slower than during other phases or during which the body part and/or clothing essentially does not move at all, the inertial sensor being arranged on body part and/or clothing of said person,
detecting the periods of time during the movement of said person, during which the inertial sensor measures no further substantial acceleration but gravitational acceleration, and thereby detecting rest phases of the body part and/or clothing of the person, during which the body part or clothing substantially does not move or is slowed,
during a plurality of the detected rest phases of the body part and/or clothing, capturing an image of the surroundings of the person by means of a camera attached to said body part and/or clothing,
determining a movement of the body part and/or clothing by processing the images of at least two rest phases, in particular temporally sequential rest phases, and
calibrating the at least one inertial sensor based on the information about the movement of the body part and/or clothing obtained from the images.

14. The method of claim 13, wherein, based on the measurement data of the at least one calibrated inertial sensor, a map of the surroundings of the person is created and in particular a Simultaneous Localization and Mapping is performed.

15. The method of claim 14, wherein, based on the images captured, a 3D model of the surroundings is created into which in particular at least parts of the images captured are integrated.

16. The method of claim 13, wherein the rest phase of the body part and/or clothing of the person is detected by the inertial sensor and/or by the evaluation of the images which in this case are captured by the camera in a continuous or quasi-continuous or an intermittent manner.

17. The method of claim 13, wherein the aperture angle of the camera is selected as a function of the stride length of the person such that the images of two successive rest phases overlap in their edge zones so that they can be combined into an overall image.

18. The method of claim 13, wherein objects visible on a first image captured are detected and, in a further step, the visual characteristics of these objects are described and stored so that these objects can be recognized in a successive image.

19. The method of claim 13 comprising the following steps:
acquiring image data of the surroundings of a plurality of persons,
transmitting these data to a processing computer, in particular a central and/or external processing computer, and
creating a general map of the surroundings of the persons from the acquired image data and/or the data of the inertial sensors.

20. The method of claim 13, wherein the at least one inertial sensor is configured as a 3D inertial sensor with at least three rotation rate sensor elements and at least three axial acceleration sensor elements.

21. A system for locating a person, in particular a pedestrian in an area, in particular inside a building, comprising
at least one inertial sensor for detecting the movement of at least one body part and/or clothing of said person, the inertial sensor being adapted to be attached to one foot or in or on a shoe of a person or of another body part or a piece of clothing of said person, which experiences phases of rest during said movement, during which phases it moves significantly slower than during other phases or during which it essentially does not move at all,
a camera for capturing images of the surroundings of the person during detected phases of rest of said body part and/or piece of clothing of said person, and
a data processing device connected with the at least one inertial sensor and the camera, the device serving to calibrate said at least one inertial sensor in accordance with the information obtained by the evaluation of a plurality of images captured during rest phases.

22. The system of claim 21, characterized by a fastening device for fastening the camera and/or the inertial sensor to a shoe, wherein the fastening device especially is a fastening clip to be fastened to a shoe by means of the shoelaces.

23. The system of claim 21, wherein the camera is rigidly connected with the inertial sensor.

24. The system of claim 21, wherein the at least one inertial sensor is configured as a 3D inertial sensor with at least three rotation rate sensor elements and at least three axial acceleration sensor elements.
